(19) United States
(12) Patent Application Publication
(10) Pub. No.: US 2023/0385021 A1
(43) Pub. Date: Nov. 30, 2023

(54) PROCESSING AUDIO CONVERSATION DATA FOR MEDICAL DATA GENERATION

(71) Applicant: Augmedix Operating Corporation, San Francisco, CA (US)

(72) Inventors: Cory ADAMS, Helotes, TX (US); Michael Francis BALLOU, Mission Viejo, CA (US); Muffakham Ali Farhan MOHAMMED, Tempe, AZ (US); Greice SILVA, Curitiba-Parana (BR); Saurav CHATTERJEE, Redwood City, CA (US); Chad GREGERSON, Walnut Creek, CA (US); Sarah Rocio NIEHAUS, Ross, CA (US)

(73) Assignee: Augmedix Operating Corporation, San Francisco, CA (US)

(21) Appl. No.: 18/310,813

(22) Filed: May 2, 2023

Related U.S. Application Data
(60) Provisional application No. 63/345,402, filed on May 24, 2022.

(51) Int. Cl. G06F 3/16; G06F 3/048

(52) U.S. Cl. CPC G06F 3/167; G06F 3/048

(57) ABSTRACT

Systems and methods for generating a complaint tree data structure based on audio conversation data of a medical visit are provided. Transcript conversation data is generated based on the audio conversation data using one or more automatic speech recognition (ASR) models. A complaint tree section corresponding to a section of the complaint tree data structure is determined based on the transcript conversation data. A plurality of medical entities corresponding to the complaint tree section are extracted from the transcript conversation data, and a relationship between two or more medical entities is determined. A complaint tree data structure is constructed based on the complaint tree section, the plurality of extracted medical entities, and the relationship between the two or more medical entities. Output data comprising an indication of one or more characteristics of the medical visit is generated based on the constructed complaint tree data structure.

### CROSS-REFERENCE TO RELATED APPLICATIONS

This application claims benefit of priority of U.S. Provisional Patent Application No. 63/345,402, filed May 24, 2022, the entire contents of each of which are hereby incorporated by reference.

### FIELD

This disclosure relates generally to electronic health record systems, and more specifically to systems and methods for processing audio conversation data to automatically generate structured medical data for electronic health records.

### BACKGROUND

Electronic health records are vital in providing, documenting, and tracking medical care across all medical fields and specialties. According to known techniques, medical practitioners and medical records specialists (e.g., scribes) manually write medical notes describing consultations with patients in order to record the patient's demographic information, prior medical information, previously prescribed medication information, complaint and symptom information, and information regarding any treatment, tests, or medication prescribed for the patient during the consultation. The handwritten notes are later translated into the electronic health record for the patient.

### SUMMARY

As described above, medical notes regarding consultations with patients are created for electronic health records by being manually written by a medical practitioner and/or medical record specialist. However, said known techniques are time-consuming and labor-intensive. Furthermore, manually creating electronic medical notes (e.g., electronic medical records) is prone to human error. Additionally, manually creating electronic medical records may produce medical notes, after-visit summaries, and/or pre-charting summaries that are not in any standardized format and may be poorly suited for future manual review/analysis and/or for future automated review/analysis. Moreover, due to a lack in standardization, the ability to utilize medical information stored in electronic health records and/or a data lake to examine trends and make data-backed decisions is hindered.

Disclosed herein are systems and methods that may improve the creation of structured medical data that may be itself stored in electronic health records (EHRs) and/or used to generate information to be stored in EHRs. Notably, a computerized system may process audio conversation data comprising medical information from a medical consultation between a medical practitioner and patient. For example, the medical information may pertain to any aspect of patient medical information, such as a symptom, onset mode of a symptom, onset timing of a symptom, frequency (e.g., of a symptom), location of a symptom, contextual information, quality of a symptom, a prior medical condition, a current medication, a medication to be prescribed, a treatment to be prescribed, lab test results, a lab test to be ordered, imaging procedure results, an imaging procedure to be ordered, an organ system, a diagnostic procedure, a diagnosis, a treatment, etc.

Using one or more automated speech recognition (ASR) models/algorithms, the system may process audio conversation data to generate transcript conversation data, which may be processed using one or more natural language processing (NLP) models to produce structured medical data (e.g., a complaint tree data structure) of the medical visit. The complaint tree data structure may be stored, in some embodiments, in an electronic health record (EHR) of the patient. The systems and methods provided herein may produce structured medical data in a manner which is more efficient, resistant to user error, flexible, configurable, and scalable than traditional written medical note creation. For example, the generated structured medical data may be used to create medical notes (e.g., electronic medical records, EMRs), medical billing codes, pre-charting summaries, after-visit summaries, care reminders, etc. Additionally, the systems and methods disclosed herein may generate and store this structured complaint tree data structure in a data lake in a consistent, structured format such that the medical data may be efficiently and accurately reviewed and analyzed (whether manually or programmatically) after creation and storage. For example, the structured medical data may be applied to systematically observe data trends across a population to make data-backed healthcare-related decisions.

In some embodiments, a system for generating a complaint tree data structure based on audio conversation data of a medical visit is provided, the system comprising one or more processors configured to cause the system to: receive the audio conversation data of the medical visit; generate transcript conversation data based on the audio conversation data using one or more automatic speech recognition (ASR) models; determine a corresponding complaint tree section based on the transcript conversation data; extract a plurality of medical entities from the transcript conversation data, wherein the plurality of medical entities correspond with the determined complaint tree section; determine a relationship between two or more medical entities of the plurality of extracted medical entities; construct a complaint tree data structure based at least in part on the complaint tree section, the plurality of extracted medical entities, and the relationship between the two or more medical entities; and generate output data comprising an indication of one or more characteristics of the medical visit based on the constructed complaint tree data structure.

In some embodiments, generating the output data comprises: extracting one or more medical entities from the constructed complaint tree data structure; and inserting the one or more extracted medical entities into a template corresponding to a type of output data.

In some embodiments, the type of output data is selected from the group consisting of: a medical note of the medical visit, a care reminder during the medical visit, an after-visit summary of the medical visit, a billing code corresponding to the medical visit, and a pre-charting summary for a subsequent medical visit.

In some embodiments, the complaint tree section is selected from the group consisting of: history of present illness, review of systems, physical examination, and assessment/plan.

In some embodiments, the audio conversation data includes a first portion comprising audio data of an individual and a second portion comprising audio data of a dialogue between two or more individuals.

In some embodiments, generating the transcript conversation data comprises: generating a first portion of the transcript conversation data using a first automatic speech recognition (ASR) model of the one or more ASR models based on the first portion of the audio conversation data; and generating a second portion of the transcript conversation data using a second ASR model of the one or more ASR models based on the second portion of the audio conversation data.

In some embodiments, the system comprises one or more processors configured to cause the system to apply one or more rules to the transcript conversation data generated by the one or more automatic speech recognition (ASR) models, the one or more rules based at least in part on a physician's specialty and/or a patient's medical history.

In some embodiments, the section is determined using a first natural language processing (NLP) model, the plurality of medical entities are extracted using a second NLP model, and the relationship between two or more entities is determined using a third NLP model.

In some embodiments, one or more of the first, second, and third natural language processing (NLP) model are trained using training data comprising annotations indicating one or more of representative medical entities, representative relationships between medical entities, and representative sections.

In some embodiments, the system comprises one or more processors configured to cause the system to, for a medical entity of the plurality of extracted medical entities, map one or more synonyms of the medical entity to the medical entity.

In some embodiments, the system comprises one or more processors configured to cause the system to, for a medical entity of the plurality of extracted medical entities, determine a medical entity type of the medical entity.

In some embodiments, the medical entity type is selected from the group consisting of: complaints, history, timing, assessment, symptoms, location, medication, tests, and treatment.

In some embodiments, the system comprises one or more processors configured to cause the system to validate the relationship between the two or more entities using medical standards and/or guidelines.

In some embodiments, the system comprises one or more processors configured to cause the system to determine a visit type based on the transcript conversation data.

In some embodiments, the visit type is selected from the group consisting of: routine care, follow-up visits for non-urgent problems, and urgent visits for acute illness.

In some embodiments, the system comprises one or more processors configured to cause the system to store the output data in an electronic health record (EHR) corresponding to a patient of the medical visit.

In some embodiments, the complaint tree data structure is constructed based on a complaint tree data structure template.

In some embodiments, the complaint tree data structure template is organized based on one or more complaint-type medical entities, each complaint-type medical entity comprising one or more sections.

In some embodiments, the system comprises one or more processors configured to cause the system to use the complaint tree data structure to generate analytics output data.

In some embodiments, a method for generating a complaint tree data structure based on audio conversation data of a medical visit is provide, the method comprising: receiving the audio conversation data of the medical visit; generating transcript conversation data based on the audio conversation data using one or more automatic speech recognition (ASR) models; determining a corresponding complaint tree section based on the transcript conversation data; extracting a plurality of medical entities from the transcript conversation data, wherein the plurality of medical entities correspond with the determined complaint tree section; determining a relationship between two or more medical entities of the plurality of extracted medical entities; constructing a complaint tree data structure based at least in part on the complaint tree section, the plurality of extracted medical entities, and the relationship between the two or more medical entities; and generating output data comprising an indication of one or more characteristics of the medical visit based on the constructed complaint tree data structure.

In some embodiments, a non-transitory computer-readable storage medium storing one or more programs for generating a complaint tree data structure based on audio conversation data of a medical visit is provided, the programs for execution by one or more processors of an electronic device that when executed by the device, cause the device to: receive the audio conversation data of the medical visit; generate transcript conversation data based on the audio conversation data using one or more automatic speech recognition (ASR) models; determine a corresponding complaint tree section based on the transcript conversation data; extract a plurality of medical entities from the transcript conversation data, wherein the plurality of medical entities correspond with the determined complaint tree section; determine a relationship between two or more medical entities of the plurality of extracted medical entities; construct a complaint tree data structure based at least in part on the complaint tree section, the plurality of extracted medical entities, and the relationship between the two or more medical entities; and generate output data comprising an indication of one or more characteristics of the medical visit based on the constructed complaint tree data structure.

### BRIEF DESCRIPTION OF THE FIGURES

Various embodiments are described with reference to the accompanying figures, in which:

FIG. 1 depicts a system for providing a medical records generation platform, in accordance with some embodiments.

FIG. 2 depicts an automatic speech recognition (ASR) system of the medical records generation platform, in accordance with some embodiments.

FIGS. 3A-3B depict a natural language processing (NLP) system of the medical records generation platform, in accordance with some embodiments.

FIGS. 4A-4E depict example medical entity extractions from transcript data of an audio conversation, in accordance with some embodiments.

FIG. 5 depicts an example process of generating a complaint tree, in accordance with some embodiments.

FIG. 6 depicts a method diagram for generating a complaint tree data structure based on audio conversation data, in accordance with some embodiments.

FIG. 7 depicts a computer for generating a complaint tree data structure, in accordance with some embodiments.

### DETAILED DESCRIPTION

As described above and in further detail below, the disclosure herein pertains to various systems, methods, computer-readable storage media, and platforms for automatically generating structured medical data for electronic health records. Traditional medical note generation techniques are time-intensive and laborious for medical practitioners and/or medical records specialists. Additionally, the generated medical notes are often structured in an inconsistent manner and are prone to human error, thus hindering their usability in later health data analytics. The systems and methods provided herein may automatically and systematically generate structured medical data (e.g., a complaint tree data structure) based on audio conversation data (e.g., between a medical practitioner and patient). The medical data may be generated in a structured manner such that the notes are easily accessible for later review and analysis (both manually and programmatically). The complaint tree data structure may be applied to create various deliverables related to the medical visit, such as a medical note, medical billing codes, care reminders during the visit, after-care summaries, pre-charting for subsequent visits, etc. The complaint tree data structure and/or various deliverables may be stored in an electronic medical records library and/or other data lake for later review and analysis.

The disclosed computerized systems may generate transcript data based on received audio conversation data using one or more automatic speech recognition (ASR) models paired with customized rules and/or context models. Audio conversation data may include, for example, medical information pertaining to any aspect of patient medical information, such as a symptom, onset mode of a symptom, onset timing of a symptom, frequency (e.g., of a symptom), location of a symptom, contextual information, quality of a symptom, a prior medical condition, a current medication, a medication to be prescribed, a treatment to be prescribed, lab test results, a lab test to be ordered, imaging procedure results, an imaging procedure to be ordered, an organ system, a diagnostic procedure, a diagnosis, a treatment, etc.

The computerized systems may use the transcript data generated by one or more ASR models and apply one or more natural-language processing (NLP) models (e.g., one or more of abstractive and/or an extractive summarizing techniques) to further process the transcript data and generate a structured medical data, for example, in the form of a complaint tree data structure. For example, processing with the one or more NLP models may include determining corresponding sections of a complaint tree data structure based on the transcript data, extracting one or more keywords and/or phrases (e.g., entities) from the transcript data that correspond to the determined sections, and mapping the keywords and/or phrases to canonical medical terminology. Sections of the data structure may include history of present illness, review of systems, physical examination, and assessment/plan. The system may determine relationships between the extracted medical entities and may use the section, extracted medical entities, and relationships between entities to create a complaint tree data structure. The complaint tree data structure may be applied to generate a data output, such as (as mentioned above) a medical note of the medical visit, an after-care summary, one or more medical billing codes, a pre-charting summary for a subsequent visit, and one or more care reminders during the visit. One or more of the data outputs and/or the structured medical data (e.g., complaint tree data structure) may be stored in an electronic health record (EHR) of the patient and/or a data lake. In some embodiments, the data output may be displayed, for example, on a graphical user interface of a user input device (e.g., mobile device, desktop, medical workstation, etc.). In some embodiments, as mentioned above, the complaint tree data structure may be applied in healthcare data analytics by analyzing data across a population. For example, data analytics may include monitoring the number of prescriptions of a given medication by a physician to determine if the medication is overly prescribed, attempting to identify a correlation between treatments and health outcomes, etc.

### Medical Records Generation Engine

Systems for processing audio conversation data and generating medical data based on the conversation data may comprise one or more processors configured to apply one or more algorithms/models, and may be communicatively coupled with one or more data stores, libraries, front-end user systems, and/or back-end user systems.

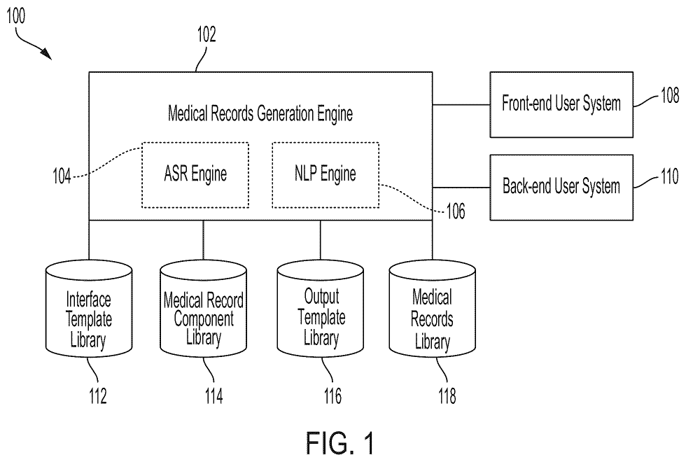

FIG. 1 illustrates a system 100 for providing a medical records generation platform, in accordance with some embodiments.

As shown in FIG. 1, system 100 may include medical records generation engine 102, which may include one or more processors configured to provide an automatic speech recognition (ASR) engine 104 and a natural language processing (NLP) engine 106. In some embodiments, engines 104 and 106 may be provided by a single processor or a common set of processors; in some embodiments, engines 104 and 106 may be provided by different processors or different sets of processors. System 100 may also include front-end user system 108, back-end user system 110, interface template library 112, medical record component library 114, output template library 116, and medical records library 118. As shown, each of the components of system 100 may be communicatively coupled (e.g., by wired and/or wireless electronic communication) with engine 102. In some embodiments, system 100 may be provided as a distributed (e.g., network) system with one or more components located remotely from one another and connected via network (e.g., wide-area network) communication. In some embodiments, system 100 may be provided as a local system with one or more components located together with one another and connected via local network communication. In some embodiments, one or more components of system 100 may be provided as part of a single computer device. In some embodiments, system 100 may provide a platform by which a front-end user of system 108 may be provided with one or more graphical user interfaces (GUIs) for generating structured medical data for electronic health records.

Medical records generation engine 102, including ASR engine 104 and NLP engine 106, may comprise any one or more processors (located locally and/or remotely from front-end system 108 and/or back-end system 110) configured to perform all or part of any of the techniques disclosed herein. In some embodiments, engine 102 may be provided, in whole or in part, as one or more processors of a personal computer, laptop computer, tablet, mobile electronic device, server, distributed computing system, and/or cloud computing system.

Engine 102 may be configured to provide one or more graphical user interfaces to front-end users of the system such that the front-end users may supply information to system 100 regarding a patient medical consultation (e.g., medical visit). For example, engine 102 may provide instructions for providing one or more graphical user interface screens to front-end user system 108 such that system 108 may display a graphical user interface and receive user inputs via said graphical user interface.

Engine 102 may then receive (e.g., via wired or wireless electronic transmission) data transmitted from front-end user system 108 regarding the user inputs detected by system 108.

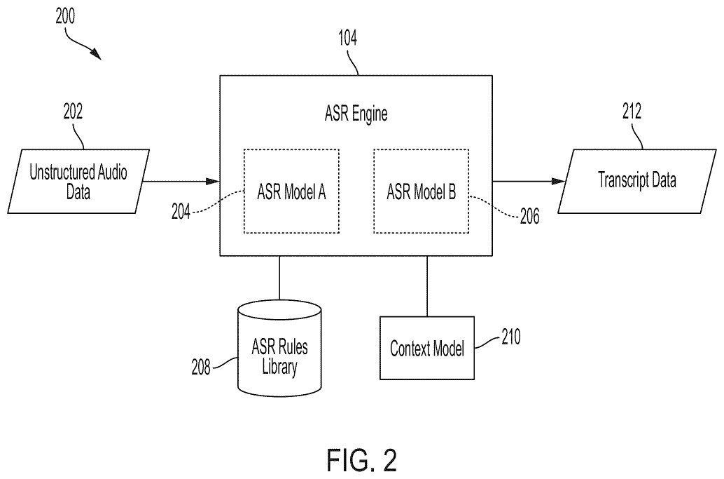

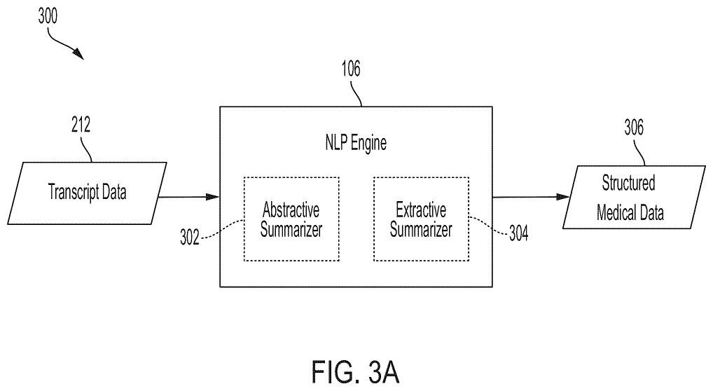

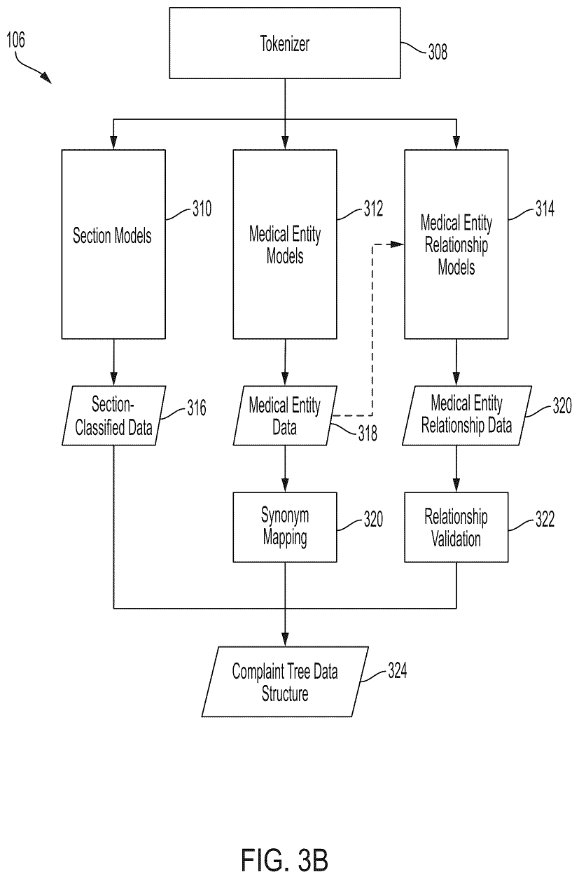

Based on the data received regarding the front-end user inputs, engine 102 may generate structured medical data for entry into an electronic health record (e.g., using ASR engine 104 and NLP engine 106, as will be described in greater detail below with respect to FIG. 2 and FIGS. 3A-3B), wherein the structured medical data may indicate one or more characteristics of the medical consultation based on the provided front-end user inputs. In some embodiments, the system may receive user inputs comprising audio data for processing from any suitable source (e.g., front-end user system 108). For example, a user interface provided by front-end system 108 may provide users the opportunity to upload audio data and/or use a personal computing device (e.g., mobile device, workstation, desktop, tablet, etc.) to capture raw audio data in real-time, and the raw audio data may then be transmitted from front-end system 108 to engine 102 for processing.

The generated structured medical data may describe medical entities such as patient demographic information, patient background information, patient medical/family history information, patient complaint information, patient symptom information, patient preexisting/past medication information, patient preexisting/past treatment information, medication prescription information, test/analysis prescription information, and/or treatment prescription information. Medical entities in the structure medical data may be used to generate various data outputs, such as a medical note, after-visit summary, pre-charting summary, medical coding, and/or care reminders. Each of the outputs may be automatically generated based on structures of phrases, sentences, and/or paragraphs that may be stored in templates accessible to engine 102 (e.g., in output template library 116). The medical data structure and/or data outputs may be stored (e.g., as part of an electronic health record in medical records library 118) and/or displayed to a user (e.g., by being transmitted to front-end user system 108 for display on a display).

Front-end user system 108 may comprise any one or more computer systems (located locally and/or remotely from engine 102) configured to receive instructions and/or transmitted data from engine 102, to render and/or display a graphical user interface to a front-end user, to detect one or more inputs executed against the graphical user interface by the user, and to transmit data regarding detected user inputs to engine 102. In some embodiments, front-end user system 108 may include any suitable display and any suitable input device (e.g., mouse, keyboard, touch-sensitive device, touchscreen, microphone, etc.). In some embodiments, front-end user system 108 may be provided, in whole or in part, as a personal computer, workstation computer, laptop computer, tablet, or mobile electronic device. Example graphical user interfaces (GUIs) of front-end user systems are described in greater detail in U.S. patent application Ser. No. 17/313,482, the entire contents of which are hereby incorporated by reference in its entirety. The front-end user system 108 is not intended to be limited to the GUI which is described in the aforementioned application. Rather, it is to be understood that other types of user interfaces may be used to render the medical data generated by engine 102.

Back-end user system 110 may comprise any one or more computer systems (located locally and/or remotely from engine 102) configured to send data to and/or receive data from engine 102. In some embodiments, back-end user system 110 may be configured to send instructions to engine 102 in order to configure the user interface to be provided to front-end system 108, such as by configuring options to be presented to front-end users of the interface and/or configuring templates (e.g., natural language sentence structures and/or paragraph structures) to be used to create data outputs, such as medical notes. In some embodiments, back-end user system 110 may be configured to receive transmissions from engine 102 regarding monitoring front-end users, system performance, system characteristics, and/or metadata collected based on use of the platform and graphical user interfaces by one or more front-end users. In some embodiments, back-end user system 110 may include any suitable display and any suitable input device (e.g., mouse, keyboard, touch-sensitive device, touchscreen, microphone, etc.). In some embodiments, back-end user system 110 may be provided, in whole or in part, as a personal computer, workstation computer, laptop computer, tablet, or mobile electronic device. In some embodiments, front-end user system 108 and back-end user system 110 may be provided on a shared device and/or may be provided as a package in the same computer system or set of computer systems, such that the front-end user and back-end user may be the same individual. Example back-end user systems are described in greater detail in U.S. patent application Ser. No. 17/313,540, the entire contents of which are hereby incorporated by reference in its entirety.

In some embodiments, medical record component library 114 may comprise any one or more computer-readable storage mediums configured to store component information that may be used in the creation of the structured data for electronic health records and/or in the creation of templates for use in the systems described herein. For example, medical record component library 114 may store data pertaining to medical specialty information, patient visit type information, patient complaint type information, complaint-element information, descriptor information (e.g., information regarding options that may be selected by users to characterize one or more complaint-elements), treatment information, test information, diagnosis information (e.g., diagnosis code information), imaging information, medications information, and/or health systems information.

In some embodiments, the data stored in medical record component library 114 may be used to create (e.g., may be incorporated into) a template executed by the system to provide a graphical user interface for a front-end user. For example, a template may be configured (e.g., by a back-end user of system 110) to provide a plurality of options to a front-end user for specifying what treatments are being prescribed to a patient, the template stored in interface template library 112. In some embodiments, the options for the template may be populated by being automatically drawn from one or more lists or sets of treatment information stored in medical record component library 114. In some embodiments, a template may populate a set of options based on an entire dataset or an entire data subset from library 114. In some embodiments, a template may populate a set of options based on a selection of specific data items from library 114, such as items specified by a back-end user of system 110 in creating the template.

In some embodiments, interface template library 112 may comprise any one or more computer-readable storage mediums configured to store the template data mentioned above. Template data may include data (e.g., one or more data structures) configured to be usable by engine 102 to provide all or part of the contents of a GUI to a user of front-end user device 108. In some embodiments, templates may govern what options are displayed to a front-end user of the system and the manner in which they are displayed to the user. In some embodiments, interface template library 112 may store different templates for different use cases, including different medical specialties, different languages, different countries, different regions, different states, different medical facilities, different doctors, different patient characteristics or classes, and/or different complaint types. In some embodiments, a front-end user may select an appropriate template based on the nature of the patient consultation (e.g., based on the purpose of the patient visit and/or what the patient's complaint is), and the selected template may cause the system to display appropriate and relevant options for such a consultation (e.g., from medical record component library 114).

In some embodiments, medical records library 118 may comprise any one or more computer-readable storage mediums configured to store structured medical data (e.g., a complaint tree data structure). For example, medical records library 118 may be a database such as the electronic health record (EHR), wherein each patient may comprise a unique health record within the EHR database that tracks medical data of the patient. As will be described in greater detail below, structured medical data may comprise one or more medical entities (e.g., keywords, phrases, etc.), sections, and relationships between medical entities, each of which may be determined using ASR engine 104 and/or NLP engine 106. In some embodiments, medical records library 118 may store data outputs generated using the structured medical data, such as medical notes of a medical visit, after-visit summaries, pre-charting summaries for subsequent medical visits, care reminders during the visit, and/or medical billing codes.

In some embodiments, output template library 116 may comprise any one or more computer-readable storage mediums configured to store a plurality of templates for creating data outputs. As mentioned above and described in greater detail below, data outputs that may be generated from the structured medical data described herein may comprise medical notes, medical billing codes, after-visit summaries, pre-charting summaries for subsequent visits, and care reminders during the visit. Thus, the templates may comprise natural language statements, phrases, numerical characters, etc. Each of the data outputs described above may be generated using unique templates, wherein the templates may be generated by a back-end user of system 110 and stored in library 116. In some embodiments, templates may be dependent on the type of output, as well as the intended end user of the output. For example, output template library 116 may store different templates for different medical specialties, different languages, different countries, different regions, different states, different medical facilities, different doctors, different patient characteristics or classes, and/or different complaint types.

Automatic Speech Recognition (ASR) Engine

As mentioned above, the medical records generation engine 102 may comprise one or more ASR models and/or natural language processing (NLP) models. ASR models may be used to process raw audio conversation data and generate transcript data.

FIG. 2 depicts an automatic speech recognition (ASR) system 200 for generating transcript data from audio conversation data, in accordance with some embodiments. The ASR system 200 may be configured to apply one or more ASR models (e.g., algorithms) to process audio data (e.g., unstructured ambient audio data representing a multi-party and/or single-party conversation) and generate output transcript data for further processing prior to generating structured medical data for use in creating outputs such as medical notes.

As shown in FIG. 2, system 200 may include ASR engine 104, which may be configured to apply one or more ASR models 204 and 206. In some embodiments, ASR engine 104 may be communicatively coupled to an ASR rules library 208 and one or more context models 210, such that ASR engine 104 may process data using one or more ASR models, followed by applying one or more ASR rules or context models to the data to generate transcript data. ASR engine 104 may receive unstructured audio data 202 (e.g., from front-end user system 108). The unstructured audio data 202 may be, for example, conversation data between a medical practitioner and a patient, dictation by a user (e.g., medical practitioner, medical record management specialist, etc.), tele-medicine conversation, or another form of audio data. In some embodiments, ASR engine 104 may dynamically select one or more models/algorithms to use to generate transcript data from the audio data 202. For example, ASR engine 104 may apply a first ASR model 204 (e.g., ASR model “A” in FIG. 2) to a first portion of audio data 202 (e.g., process a first portion of audio data 202 with ASR model “A”), and a second ASR model 206 (e.g., ASR model “B” in FIG. 2) to a second portion of audio data 202 (e.g., process a second portion of audio data 202 with ASR model “B”). In some embodiments, the ASR model options may comprise distinct features from one another for processing a specific type of audio data. For example, ASR model 204 may specialize in processing multi-party conversation audio data, wherein ASR model 206 may specialize in processing single-party dictation audio data. In some embodiments, an ASR model option may specialize in processing audio data related to a specific medical context (e.g., a specific medical specialty). In some embodiments, an ASR model option may specialize in processing audio data comprising one or more types of dialects.

System 200 may comprise a plurality of ASR models (e.g., algorithms). For example, system 200 may access a remote and/or local database/server to retrieve one or more ASR models (e.g., third-party models). In some embodiments, system 200 may add, update, and/or remove one or more ASR models to ASR engine 104. For example, a back-end user may retrieve (e.g., from one or more remote databases/servers) an ASR model, and the ASR model may be installed for use by ASR engine 104. In some embodiments, ASR engine 104 may automatically remove and/or update one or more ASR models of system 200, for example, based on metadata collected regarding performance and/or use of the ASR model.

In some embodiments, one or more ASR models may be tailored and/or customized, for example, for medical terminology typically used in one or more medical specialties of interest. System 200 may comprise and/or access any number of ASR algorithms and is not limited to the two example ASR models 204 and 206 as depicted in FIG. 2. In some embodiments, ASR engine 104 may be configured to dynamically select a given ASR model for at least a portion of unstructured audio data 202 from a plurality of ASR models. The selection between available ASR models may be based on a set of predefined rules that assess content of the conversation data and/or metadata associated with the conversation data in order to make the selection. As described herein, the selection between available ASR models may be executed by a decision model. For example, ASR engine 104 may be configured to determine one or more characteristics of audio data 202 (e.g., language, dialect, number of parties, audio quality, etc.), and based on the determined characteristics, may select an ASR model for processing. In some embodiments, ASR engine 104 may test each candidate ASR model for a segment of audio data 202 and determine one or more ASR models that perform best for the segment of audio data. For example, given a first segment of audio data that comprises primarily conversation data between a patient and physician, the ASR engine 104 may apply at least ASR model 204 and ASR model 206 to the first segment of audio data, and the system (or in some embodiments, a back-end user) may assess the performance of each ASR model for the segment of audio data. In another embodiment, another decision model and/or rule chooses which ASR model to use for audio data to optimize transcription accuracy, for example, by running multiple ASRs in parallel for a short duration and then determining which ASR model to use for the full duration of the audio. The system 200 may then apply the selected ASR model to each subsequent segment of the audio data which comprises a similar format (e.g., multi-party conversation), keywords, patterns, or other characteristics. Thus, the ASR engine may dynamically apply a plurality of ASR algorithms to a single unstructured audio dataset 202 to generate a comprehensive, accurate transcript dataset.

In some embodiments, one or more ASR models 204, 206 may remove any filler words or disfluencies (e.g., stuttering, hesitations, etc.) from unstructured audio data 202. In some embodiments, one or more of ASR models 204, 206 may comprise a traditional hybrid ASR method, wherein decoding the raw audio data may generally comprise an acoustic model, lexicon model (e.g., pronunciation dictionary), and language model. For example, ASR model “A” may receive unstructured audio data 202 and generate a sequence of numbers (e.g., acoustic features) from the audio soundwaves within unstructured audio data 202, the sequence of numbers readable by a computerized system. The acoustic model may map the string of acoustic features to phonemes (e.g., distinct units of sounds), and the lexicon model may map these phonemes to actual words. In some embodiments, the language model may determine a probable word sequence (e.g., transcript) based on the words generated by the decoding process.

In some embodiments, one or more ASR models (e.g., ASR model “B”) may use a particular deep learning model that specializes in recognizing various dialects and/or accents to generate transcript data. In some embodiments, the ASR models may be trained to perform well for specific use cases (e.g., in a medical context). The deep learning ASR model may comprise an encoder module and a decoder module. In some embodiments, the encoder module may generate a summary of the unstructured audio data 202, wherein the summary extracts one or more acoustic characteristics that are important for distinguishing between speech sounds. In some embodiments, the decoder module may receive from the encoder the summary of audio data and convert the data to characters.

Each of the traditional hybrid ASR models and/or deep learning ASR models may require training. One or more ASR models may be trained via an active learning process, wherein the model autonomously and/or dynamically learns and adopts new words during use. In some embodiments, transcript data produced by one or more ASR models within ASR engine 104 may be stored, along with the corresponding unstructured audio data 202, as training data for other ASR models. Training data may instead or additionally comprise data comprising errors by the one or more ASR models in generating transcript data that may be manually corrected by a user, the correction and the error stored in relation to one another to be used as training data. By storing data produced by one or more ASR models 204 and/or 206, the vocabulary of the one or more ASR models may be continuously expanded.

In some embodiments, ASR models 204, 206 may produce a plurality of candidate outputs for a given input of audio data. The candidate outputs may be mapped, for example, in a “lattice” data structure, wherein multiple inferences of word sequences from a given audio data input are linked within the lattice data structure. The ASR engine 104 may determine and apply one or more decision models to determine the word sequence(s) that are most accurate within a lattice data structure. For example, in a lattice of word sequences, each link between words in a candidate word sequence may be assigned a score. In the instance the lattice is based on the output of a traditional hybrid ASR model, the score may be based on each of the three or more components of the model (e.g., acoustic, lexicon, and language model). In an end-to-end deep learning ASR model, a decoder module of the model may provide a score for a given link in the lattice. The highest score produced from a path of links may indicate a word sequence in a lattice of words, and the word sequence may be inserted as a portion of the output transcript data.

The transcript data may be further processed by one or more additional components of the ASR system 200, such as by applying one or more rules stored in ASR rules library 208 and/or by applying one or more context models 210. In some embodiments, rules may be applied uniformly to the transcript (e.g., to the entire transcript in a predefined manner) generated by ASR engine 104. In some embodiments, rules may be selectively applied to portions of interest within a given transcript generated by ASR engine 104. For example, a first set of ASR rules may be applied to a portion of transcript data including single-party dictation, and a second set of ASR rules may be applied to a second portion of transcript data including conversation data (e.g., between a medical professional and a patient). ASR rules stored in library 208 may be hard-coded (e.g., by a back-end user) and inputted via one or more back-end systems 110. In some embodiments, ASR rules library 208 may include, for example, formatting rules, instructions, and/or misspelling rules. The rules library 208 may be periodically updated (e.g., automatically by ASR engine 104 and/or manually by a user of back-end user system 110), for example, based on metadata regarding performance of the ASR models received from front-end user system 108.

In some embodiments, ASR rules library 208 may include one or more number formatting rules (e.g., changing “102 degrees” to “102°”, “hundred and 5” to “105”, “one oh two” to “102”, etc.), instruction rules (e.g., changing “number 1” to “1.”, etc.), spelling rules (e.g., correcting spelling of unique medications and/or medical diagnoses), spacing rules (e.g., correcting a misplaced space, adding, or deleting spaces between words/phrases, etc.), and contraction rules (e.g., correcting for contractions in words). The ASR rules library 208 may be updated by a back-end user periodically during use of the system, for example, to remain in accordance with newly released medications.

In some embodiments, ASR system 200 may be configured to apply one or more context models 210 to transcript data generated by one or more ASR models of ASR engine 104. In some embodiments, applying a context model 210 may require the use of intelligence to determine one or more words and/or phrases that are related to a given word and/or phrase. The context model(s) 210 may be, for example, specialty- and/or complaint-driven models. For example, the intelligence may be based on context such as patient history, clinician specialty, clinician identity, and/or history of complaints and/or medication associated with a physician. In a non-limiting example, the system may leverage contextual data to make selections or corrections for similar-sounding medication names, for example by selecting (or correcting) a medication name based on a patient's history (or lack thereof) with a condition that the medication treats, a patient's history with other medications, and/or a clinician's history in assigning the medication and/or treating associated conditions. For example, an ASR model may comprise the medication “copaxone” as generated by an ASR model (e.g., ASR model 204 and/or 206). However, the one or more context models may comprise intelligence which identifies and defines copaxone (e.g., a medication used to treat multiple sclerosis), and, based at least on the patient medical history and/or clinician background, for example, the context model may determine that the recognition of “copaxone” by the ASR model is incorrect. The one or more context models 210 may reference at least the patient's history and/or the clinician's history (e.g., stored in medical records library 118) to determine the correct medication. In some embodiments, the context model(s) 210 may additionally or instead reference a medical terminology library (e.g., stored, for example, in medical record component library 114) to identify one or more correct medications, conditions, etc. For example, if the same clinician typically sees patients struggling with an opioid addiction, the one or more context models may determine the correct medication to be “suboxone,” and may apply the context model 210 to the transcript data to make the correction to (or identify) at least that medical entity. The one or more context models 210 may prove beneficial in modifying medical terminology (e.g., including but not limited to medication types) that may be experienced less frequently in training data of the ASR models. For example, the context model may recognize “tibialis” in the transcript data and correct the entity to “tibial.” Likewise, the one or more context models 210 may identify “dorsal flexion” in the transcript data and correct the entity to “dorsiflexion.” In some embodiments, context models 210 may be used to identify (e.g., flag) words and/or phrases within transcript data for manual review by a user (e.g., a back-end user). The back-end user may accept, reject, and/or replace the flagged words and/or phrases to update the transcript data. The corrections made manually by a back-end user and/or automatically by the system (e.g., one or more context models 210) may be stored such that subsequent instances of the same words and/or phrases can be correctly interpreted by the system with minimal additional review.

In some embodiments, one or more context models 210 may be applied to transcript data generated by ASR engine 104 before, simultaneously, or after processing the transcript data with one or more rules from ASR rules library 208. In some embodiments, each of the rules from ASR rules library 208 and context models 210 may be applied to the full input transcript data. In some embodiments, the transcript data may be processed in pieces (e.g., broken up by dialogue portions, sentences, phrases, words, etc.). Following processing the transcript data with one or more context models 210 and/or rules from ASR rules library 208, ASR engine 104 may produce a transcript data output 212 for further processing with a natural language processing system (e.g., NLP engine 106).

### Natural Language Processing (NLP) Engine

As mentioned above, the medical records generation engine 102 may comprise one or more NLP models and/or automatic speech recognition (ASR) models. NLP models may be used to process transcript data and generate structured medical data. For example, NLP models may receive a large transcript dataset of a medical consultation and may process the dataset to determine key points of the consultation and may summarize these key points in a structured dataset, such as a complaint tree data structure.

FIGS. 3A-3B depict a natural language processing engine 106 of the medical record generation platform 102, in accordance with some embodiments. The natural language processing (NLP) engine 106 may be configured to apply one or more NLP models (e.g., algorithms) in order to process transcript data 212 and generate structured medical data 306. In some embodiments, the structured medical data 306 may be used in data analytics, for example, to make data-backed healthcare decisions. In some embodiments, the structured medical data 306 may be used to generate different types of outputs, such as a medical note of the visit, an after-visit summary, a pre-charting summary for subsequent visits, care reminders (e.g., notifications) during the visit, and/or medical billing codes. The data outputs may be generated, for example, by applying the structured medical data 306 to templates, as mentioned above, wherein the templates for one or more of the data output types may comprise meaningful phrases and sentences in natural language form. In some embodiments, the NLP system may be configured to apply a combination of abstractive summarizer algorithms 302 and extractive summarizer algorithms 304, as shown in FIG. 3A. In some embodiments, the NLP system may apply one or more decision models to determine when and to what portions of transcript data 212 to apply abstractive summarization, extractive summarization, or both. For example, in a similar manner as described above with respect to ASR models, different NLP models may be applied to a given segment of transcript data 212, and the NLP model that performs best (as identified by one or more decision models) may be selected for the given segment.

Prior to one or more abstractive summarization algorithms 302 and/or extractive summarization algorithms 304, NLP engine 106 may include one or more pre-processing steps. Pre-processing steps in natural language processing may include one or more of stop word removal, tokenization, stemming (e.g., reducing words to their root form), parts-of-speech tagging, etc. For example, NLP engine 106 may comprise a tokenizer 308 configured to perform one or more pre-processing steps on transcript data 212, as will be described in greater detail below with respect to FIG. 3B.

Abstractive summarizer 302 may include one or more algorithms (e.g., transformer models) that summarize one or more portions of transcript data 212 in an abstract manner using natural language generation techniques. The output summary generated by abstractive summarizer 302 may in some examples be more concise and/or read as more clinical than the input transcript data. In some embodiments, abstractive summarizer 302 may generate one or more new phrases and/or sentences for inclusion in structured medical data 306 based on transcript data 212 that were not previously found in transcript data 212. For example, abstractive summarizer 302 may process the transcript data 212 to determine an intent (e.g., meaning) in one or more portions of the transcript data 212, and may generate a sentence, word, and/or phrase using the determined intent. The one or more new phrases, words, and/or sentences generated by abstractive summarizer 302 may be incorporated to a portion of structured medical data 306. In some embodiments, abstractive summarizer 302 may apply one or more NLP models to infer characteristics related to the medical consultation, such as visit type (e.g., routine care, follow-up visits for non-urgent problems, and urgent visits for acute illness, etc.), section type (e.g., corresponding to sections of a medical note, such as history of present illness, review of systems, physical examination, and assessment/plan), medical coding (e.g., evaluation and management (E/M) coding, ICD-10 coding), complaint IDs, etc.

In addition to abstractive summarizer 302, NLP engine 106 may include extractive summarizer algorithm 304. The extractive summarizer 304 may extract the relevant entities of the transcript data 212 and include these in the structured output (e.g., a complaint tree data structure). Each extracted entity may correspond to, for example, a problem (or complaint), a symptom, onset mode of a symptom, onset timing of a symptom, timing or frequency information, location of a symptom, contextual information, quality of a symptom, a prior or current medical condition, a diagnosis, a prior or current medication, a medication to be prescribed, a prior or current treatment, a treatment to be prescribed, prior or current lab tests, lab tests to be ordered, lab test results information, prior or current imaging procedures, imaging procedures to be ordered, imaging procedure results information, an organ system, a prior or current diagnostic procedure, a diagnostic procedure to be prescribed, results of a diagnostic procedure, prior or current treatments, a treatment to be prescribed, and/or physical exam elements. Each entity may be a word or a phrase. The extractive summarizer 304 may map extracted colloquial entities to a more formal medical canonical terminology. For example, acid reflux may be mapped to gastroesophageal reflux (GER).

In some embodiments, NLP engine 106 may apply a combination of abstractive and extractive summarization techniques (e.g., otherwise referred to herein as “mixed summarization”) to generate structured data. With reference to FIG. 3B, NLP engine 106 may include a tokenizer 308 configured to generate a tokenized version of transcript data 212, and the tokenized version of transcript data 212 may then be used as input to one or more NLP models, illustrated as parallel pipelines in FIG. 3B. In some embodiments, tokenizer 308 may process the transcript data 212 prior to processing with either abstractive or extractive summarizers. In some embodiments, tokenizer 308 may, for example, remove punctuation and split the transcript data 212 into words, characters, sub-words, etc. (e.g., tokens).

A classifier may be used to generate additional information. In some embodiments, a classifier may comprise one or more models configured to determine sections (e.g., history of present illness, review of systems, physical examination, assessment/plan, etc.) for the tokenized transcript data (e.g., pipeline 310). It is to be understood that section options are not limited to the aforementioned sections, but rather may be generated and/or selected based on the preference of an individual, group of individuals, hospital/medical office, healthcare system (e.g., group of medical offices and/or hospitals), etc. Likewise, the section options may be selected based on visit type, such as in-patient visit, out-patient visit, primary care visit, specialty visit, etc.

Each of the parallel pipelines shown in FIG. 3B may comprise one or more NLP models configured to process the tokenized transcript data received from tokenizer 308 and to generate, based thereon, data that may be used to generate a complaint tree data structure. In some embodiments, one or more of the NLP models may include an encoder component upstream of a decoder component. In some embodiments, a first NLP model may comprise the encoder component, and a second NLP model may comprise the decoder component, the encoder component configured to pass an output to the decoder component. For example, the decoder component may comprise a named entity recognition (NER) layer, a classification layer, etc. In some embodiments, NLP engine 106 may comprise one or more NLP models configured to determine sections (e.g., history of present illness, review of systems, physical examination, assessment/plan, etc.) for the tokenized transcript data (e.g., pipeline 310). In some embodiments, NLP engine 106 may include one or more NLP models configured to extract medical entities from the tokenized transcript data (e.g., pipeline 312). In some embodiments, NLP engine 106 may include one or more NLP models configured to determine a relationship between one or more medical entities (e.g., pipeline 314). In some embodiments, NLP engine 106 may include additional pipelines (e.g., sets of NLP models) configured to determine one or more additional features of a medical note, such as the visit type, medical coding, and complaint IDs (not illustrated for simplicity in FIG. 3B).

As described herein, the one or more models described with respect to FIG. 3B may utilize a combination of abstractive and extractive summarization techniques. For example, a given model may utilize abstractive and/or extractive summarization techniques. In some embodiments, one or more models of NLP engine 106 may utilize abstractive summarization (e.g., abstractive summarizer 302), and one or more other models of NLP engine 106 may utilize extractive summarization (e.g., extractive summarizer 304). For example, with reference to the parallel pipeline structure illustrated in FIG. 3B, a first NLP model illustrated with respect to pipeline 310 may be an abstractive summarizer, whereas a second and/or third NLP model illustrated with respect to pipelines 312 and 314, respectively, may be extractive summarizers. It is to be understood that any combination of NLP models, whether utilizing abstractive summarization techniques, extractive summarization techniques, or combinations thereof, can be encompassed in NLP engine 106. Stated otherwise, NLP engine 106 is not intended to be limited to the 3 parallel pipelines 310, 312, 314 illustrated in FIG. 3B.

As described above, NLP engine 106 may comprise one or more section models 310 configured to determine one or more sections associated with the tokenized transcript data. The section models 310 may comprise an encoder-decoder structure. In some embodiments, the one or more section models 310 may utilize abstractive summarization techniques described herein with reference to abstractive summarizer 302. In some embodiments, the section models 310 may comprise a classification layer configured to classify segments of transcript data into one or more section types. The section types may be associated with the visit segment, at least because the sections (e.g., of a complaint tree data structure) may correspond to the segments of a medical consultation. For example, a medical consultation may include pre-defined sections such as history of present illness (HPI), review of systems (ROS), physical examination (PE), and assessment/plan (A/P). Each of these sections may translate into a section of the complaint tree data structure to be filled, and in some embodiments, a medical note to be generated using the data stored in the complaint tree data structure. However, the visit segment may not be mentioned throughout the medical consultation; thus, from the transcript data 212, one or more sections may be determined (e.g., inferred) using NLP models. In some embodiments, NLP engine 106 may include a pipeline comprising one or more section models 310. The models may be configured to understand contextual relations between words and phrases to determine sections for portions of the tokenized transcript data. In some embodiments, the section models 310 may include an encoder comprising a language representation model, such as a BERT-variant model (e.g., RoBERTa, BERT base, ALBERT, BERT large, etc.) pre-trained using annotated data. For example, the models described herein may be trained using transcript data comprising annotations indicating key words/phrases to be extracted, relationships between words/phrases, and/or section types associated with given words/phrases. In some embodiments, training data may comprise previously processed data comprising one or more errors by the models that have been manually corrected by a user, such that the models can learn from the errors. The section encoder may receive tokenized transcript data as an input and prepare an output for a decoder.

To determine the sections for the tokenized transcript data, a decoder may process data passed from a language representation model in the section pipeline. The decoder may include a classification layer (e.g., classifier) configured to classify the data based on the pre-defined sections (e.g., HPI, ROS, PE, A/P, etc.). In some embodiments, section models 310 may comprise a classification layer corresponding to each pre-defined section. For example, an HPI classifier may receive output data from encoder 310 and classify whether the output data should be classified with the HPI section. In some embodiments, a single classification layer may determine the section corresponding to portions of the transcript data. Thus, the one or more section models 310 may generate section-classified data 316.

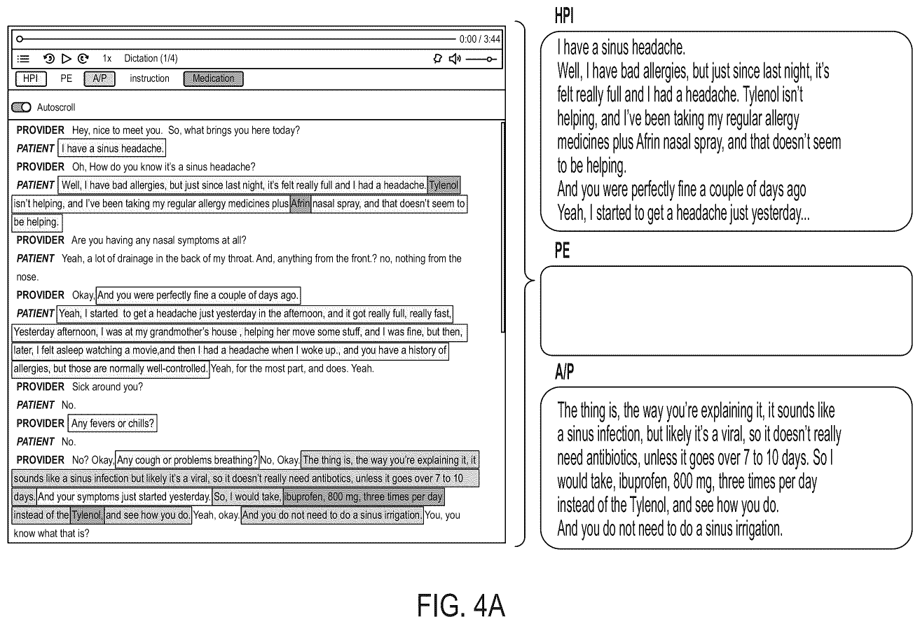

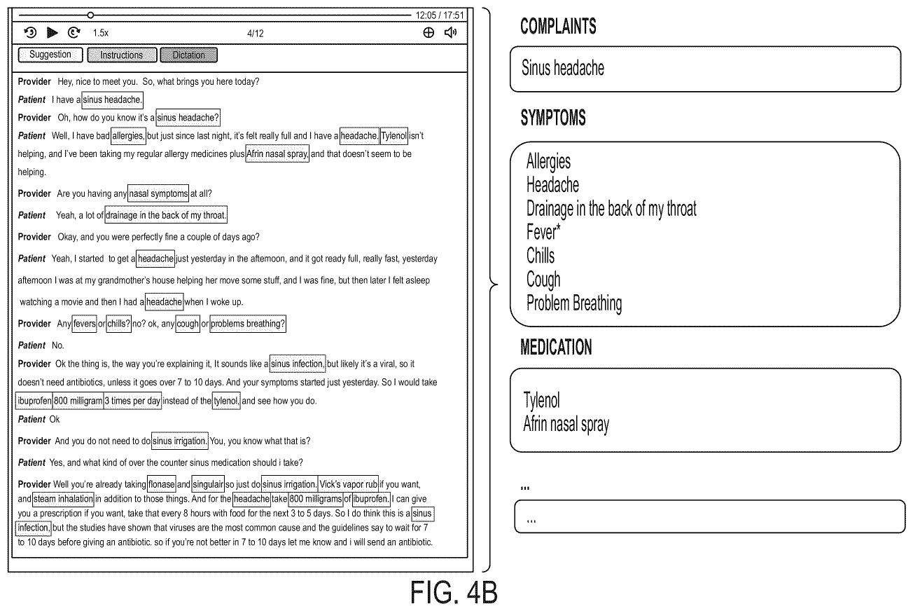

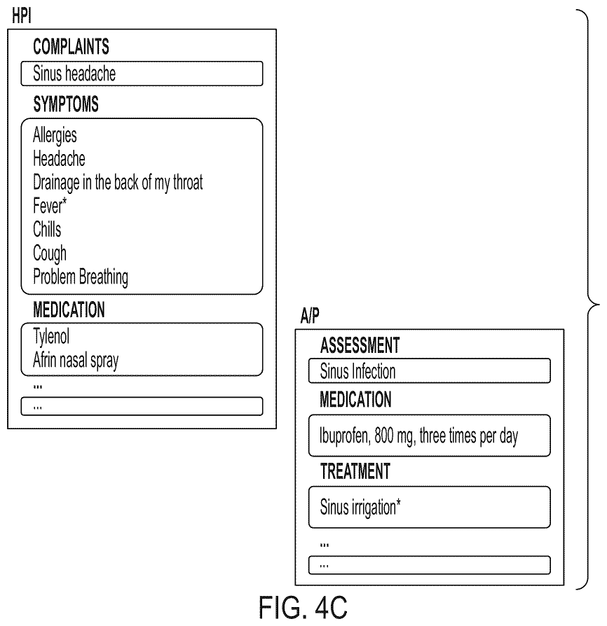

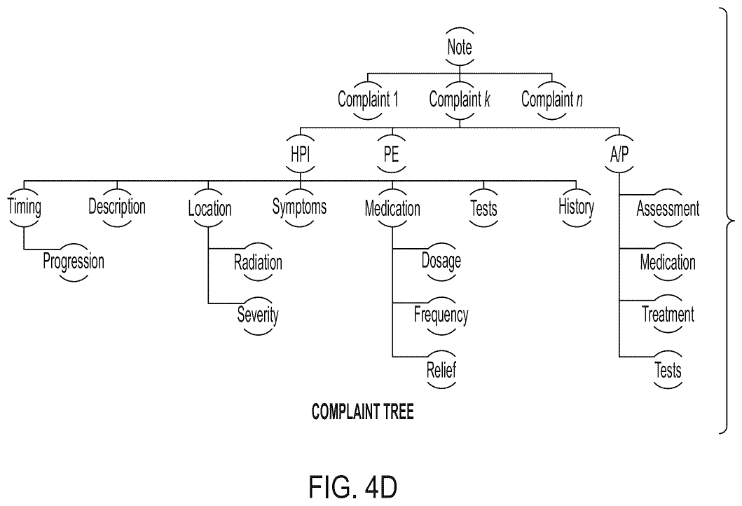

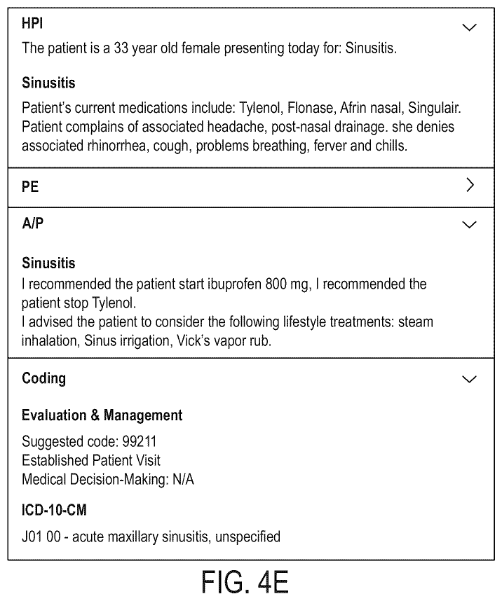

FIG. 4A illustrates example transcript data with portions of the transcript data classified into sections (e.g., HPI, PE, A/P). The section models 310 may classify full sentences, phrases, and/or words from transcript data 212 based on the pre-defined sections. In some embodiments, portions of transcript data 212 may be grouped based on the labels, as illustrated in FIG. 4A. For example, section model 310 may classify sentences, phrases, and/or words comprising symptoms and supporting phrases to the symptoms (e.g., onset timing, current treatment, etc.) within the HPI section. Additionally, the models 310 may classify the diagnosis from the medical professional, recommended treatment (including dosage and frequency of dosage) in the assessment/plan (A/P) section. In some embodiments, the system may not be required to classify words, phrases, and/or sentences into each of the pre-defined sections, at least because each medical visit may comprise different segments (e.g., the medical consultation may not require a physical examination to produce a diagnosis).

Returning to FIG. 3B, subsequently or concurrently with section models 310, an additional pipeline may be configured to extract one or more medical entities from tokenized transcript data. The models may comprise an encoder-decoder structure similar to the section models 310 described above. In some embodiments, the medical entity models 312 may comprise one or more spaCy-variant models (e.g., scipaCy models, such as scipaCy/med7) and one or more named entity recognition (NER) layers configured to extract and identify types of medical entities. In some embodiments, the medical entity models 312 may be pre-trained with biomedical data (e.g., research articles, scientific publications, etc.). For example, as described herein, the models may be trained using transcript data comprising annotations indicating biomedical words/phrases to be extracted and/or relationships between biomedical words/phrases. In some embodiments, training data may comprise previously processed data comprising one or more errors by the models that have been manually corrected by a user, such that the models can learn from the errors.

In some embodiments, a model may be applied that specializes in identifying a specific type of medical entity and/or group of medical entities. For example, different NLP models may be applied for different medical specialties, conditions, symptoms, complaints, medications, etc. For example, a first medical entity model may be trained to identify complaints and a second medical entity model may trained to identify medications. In some embodiments, a first medical entity model may be used to extract high-frequency (e.g., commonly reported) complaints, and a second, more specialized (e.g., highly trained) model may be used to extract low-frequency (e.g., rare) complaints. In some embodiments, a medical entity model may be applied that specializes in identifying a medical condition and one or more attributes related to the condition. For example, a model may extract a medical condition, as well as medications, dosages, dosage frequencies, etc. related to the condition using the same medical entity model. In some embodiments, the medical entity model may also recognize relationships between the entities.

As described above, medical entity models 312 may comprise one or more named entity recognition (NER) layers configured to extract and identify types of medical entities. For example, the one or more medical entity models 312 may extract a group of medical entities that are labeled (e.g., tagged) based on type. As mentioned above, types of medical entities may include a symptom, onset mode of a symptom, onset timing of a symptom, timing or frequency information, location of a symptom, contextual information, quality of a symptom, a prior or current medical condition, a diagnosis, a prior or current medication, a medication to be prescribed, a prior or current treatment, a treatment to be prescribed, prior or current lab tests, lab tests to be ordered, lab test results information, prior or current imaging procedures, imaging procedures to be ordered, imaging procedure results information, an organ system, a prior or current diagnostic procedure, a diagnostic procedure to be prescribed, results of a diagnostic procedure, prior or current treatments, and/or a treatment to be prescribed. In some embodiments, labeling the medical entities 318 may comprise mapping each of the extracted medical entities to the corresponding entity type. The medical entities 318 may be provided as output from the one or more medical entity models 312.

In some embodiments, as shown in FIG. 3B, the medical entities 318 may additionally be processed using one or more synonym mapping models 328. In some embodiments, synonym mapping may include mapping one or more medical entities 318 to one or more similar words of the medical entity. For example, a given medical term may comprise an informal and a formal term, such as “fainting” and “syncope.” The system may determine one or more synonyms for each of the labeled medical entities using one or more medical terminology libraries (e.g., stored in medical record component library 114). The identified synonyms may be appended to the data structure of the corresponding medical entity 324.

FIGS. 4B-4C illustrate example transcript data with one or more words and/or phrases from the transcript data classified into medical entity groups. The medical entity models 312 may label and group phrases, words, and/or sub-words from the tokenized transcript data into the pre-defined medical entity types. For example, medical entity models 312 may classify phrases, words, and/or sub-words comprising complaints, symptoms, medications, etc. to the corresponding medical entity type (e.g., category). Additionally, medical entity models 312 may classify supporting words/phrases to the complaints, symptoms, and/or medications (e.g., onset timing, anatomical location of symptom, medication dosage, etc.) to the corresponding medical entity type. In some embodiments, the system may not be required to classify phrases, words, and/or sub-words into each of the pre-defined medical entity types, at least because each medical entity type may not exist in a portion of transcript data (e.g., the medical consultation may not mention a medication).

In some embodiments, determining the relationship between medical entities may require additional models to process the tokenized transcript data. For example, associated properties of a medication type (e.g., medication dosage, dosage frequency, etc.) may be extracted using medical entity models 312 described above; however, the relationship between the medication type and the medication dosage, for example, may not be extracted with the medical entities. Returning to FIG. 3B, NLP engine 106 may comprise an additional processing pipeline comprising one or more medical entity relationship models 314 configured to determine relationships between medical entities. The medical entity relationship models 314 may comprise an encoder-decoder structure, as described above with respect to section models 310 and/or medical entity models 312. For example, medical entity relationship models 314 may comprise one or more language representation models and classification layers. Medical entity relationship models 314 may be configured to process tokenized transcript data subsequently to or concurrently with one or more NLP models illustrated in other pipelines in FIG. 3B (e.g., medical entity models 312 and/or section models 310).

In some embodiments, medical entity relationship models 314 may receive as an input one or more of the tokenized transcript data and/or one or more extracted medical entities 318. In some embodiments, the relationship model 314 may identify one or more patterns in the tokenized transcript data to determine relationships between medical entities. Medical entity relationship encoder 314 may include an encoder-decoder architecture comprising a BERT-variant model (e.g., RoBERTa, BERT base, ALBERT, BERT large, etc.) pre-trained using annotated data. For example, the models may be trained using transcript data comprising annotations indicating words/phrases to be extracted and/or relationships between words/phrases. In some embodiments, training data may comprise previously processed data comprising one or more errors by the models that have been manually corrected by a user, such that the models can learn from the errors.

In some embodiments, one or more relationship models 314 may determine whether pairs or sets of medical entities are related from the tokenized transcript data and/or medical entity data 318. The classification layer may classify the medical entities, for example, using one or more pre-defined medical entity relationships. For example, relationships may include symptoms with related entities such as a location of the symptom, onset timing of the symptom, description of the symptom, frequency of the symptom, quality of the symptom, etc. In some embodiments, relationships may include medications with related entities such as dosage, frequency of dosage, instructions for the medication, etc. In some embodiments, the tokenized transcript data may comprise a plurality of medical entities labeled as complaints, each of the complaints related to a unique set of symptoms, medications, diagnoses, etc. The medical entity relationship models 314 may be configured to distinguish between and identify relationships between the complaint groups of medical entities in the tokenized transcript data to produce medical entity relationship data 320. In some embodiments, the medical entity relationship data 320 may be passed through one or more validation models 322 configured to validate the predicted relationships, for example using one or more predefined rulesets. In some embodiments, relationship validation models 322 may utilize medical standards and/or guidelines (e.g., stored in medical records builder library 114) to validate relationship data 320. For example, the model may validate whether an identified relationship between one or more of a medication, a dosage, and a unit (e.g., metric or imperial) corresponds with medical guidelines. Relationship validation may increase accuracy by ensuring uncommon combinations are removed.

The pipeline diagram of NLP engine 106 shown in FIG. 3B may comprise a plurality of additional pipelines not illustrated for simplicity. For example, as described above, the medical entity pipeline (e.g., medical entity models 312) may comprise a plurality of pipelines configured to identify and extract unique types of entities. In some embodiments, NLP engine 106 may additionally include pipelines for determining medical coding, visit type, and/or complaint IDs, as mentioned above. In some embodiments, one or more of the pipelines may be configured to process the tokenized transcript data at substantially the same time. In some embodiments, the pipelines may be configured to process the tokenized transcript data sequentially, such that the output of one pipeline may be used as an input to a second pipeline (e.g., in relation to medical entity data 318 and the entity relationship models 314).

The section data 316, medical entity data 318, and relationship data 320 generated using the NLP models of NLP engine 106 may be compiled to a data structure (e.g., complaint tree data structure) that may serve as the basis for generating various types of output data (e.g., a medical note), as will be described in greater detail below. In some embodiments, a structure for the complaint tree may be stored (e.g., in medical record component library 114) and referenced to generate the complaint tree data structure with at least the section, medical entity, and relationship data.

FIG. 4D illustrates a complaint tree data structure generated using section data 316, medical entity data 318, and relationship data 320. In some embodiments, the complaint tree data structure may include additional medical data related to a patient (e.g., stored in and extracted from medical records library 118). In some embodiments, the complaint tree data structure may organize extracted portions of data from transcript data 212 by complaint. As mentioned above, in some embodiments, a medical consultation may comprise more than one patient complaint, and each complaint may be further divided by visit segment (e.g., section), as introduced in FIG. 4C. In some embodiments, data classified within a section of a first complaint may also be classified within the same section in a second complaint (e.g., two complaints may be evaluated with the same physical examination). FIG. 4D shows a tiered data structure from a single complaint (e.g., complaint “k”) for simplicity, however, it is to be understood that each complaint identified from the medical consultation data may comprise a similar structure.

As described above at least with respect to FIGS. 4A-4C, each of the sections of a standard medical note structure, such as history of present illness (HPI), physical examination (PE), and assessment/plan (A/P) may comprise a plurality of medical entity types. The medical entity types may be joined with those that are related (e.g., based on relationship data 320) in the data structure. The relationships may be illustrated at least by the connections and tiers within the complaint tree data structure illustrated in FIG. 4D. For example, the entity type “location” (e.g., anatomical location of a complaint) within HPI may be further described by and connected to entity types such as “radiation” and “severity.” Likewise, as mentioned above, the medical entity of “medication” may be further described by and connected to entity types such as “dosage,” “frequency,” and “relief.” Other example medical entity types that may be grouped within the section HPI may include “timing” (e.g., frequency of the complaint occurring, further described by and connected to “progression”), “description,” “symptoms,” “tests,” and “history.”

In some embodiments, the section A/P may comprise medical entity types such as “assessment,” “medication,” “treatment,” and “tests.” Test data classified within A/P may be different from that which is classified in HPI at least because the NLP models described above may differentiate between historical (e.g., previous) medical tests, and tests ordered/to be performed. Likewise, medication data classified in A/P compared to HPI may vary in that HPI medication data may refer to current medications, whereas A/P medication data may refer to medications to be prescribed. In some embodiments, the complaint tree data structure may comprise additional sections (e.g., review of systems (ROS), etc.) not illustrated in FIG. 4D. The medical entity types illustrated at least in FIG. 4D are merely an example and are not intended to limit the scope of medical entity types that may be employed in a complaint data tree structure.

Returning to FIGS. 3A-3B, NLP engine 106 may compile the structured medical data generated by extractive summarizer 304 and/or abstractive summarizer 302 to create a cohesive structured medical dataset 306. In some embodiments, entities stored in the structured medical data may be rendered into different types of data outputs based on the type of output desired by the user. For example, the user may request a medical note of the medical visit, and using one or more medical note templates (e.g., stored in output template library 116), the system may generate the medical note. In some embodiments, the medical note template may include sections headers corresponding to each of the sections of the complaint tree data structure. In some embodiments, the template may include sub-sections for different complaint types. In some embodiments, the medical note structure may be based on practitioner information, user specialty, a healthcare system, a payer, and/or a clinician preference. FIG. 4E illustrates a portion of an example medical note comprising an HPI, PE, A/P, and coding section generated using at least medical entities stored in the complaint tree data structure 324. The structured data and/or medical note may be stored, for example, in a medical records library 118 (e.g., electronic health record (EHR) corresponding to the patient).

As mentioned above, output data may include a medical note of the medical visit, a pre-charting summary for subsequent visits, an after-visit summary, care reminders (e.g., notifications) during the visit, and medical billing codes. In some embodiments, the system may reference one or more templates (e.g., stored in output template library 116) comprising predefined syntactical sentence structures dependent on the type of output. For example, an after-visit summary, which may be a summary of the medical visit for the patient's review, may use a template selected from a group of templates that may be geared towards patients. On the other hand, a medical note, which summarizes the medical visit for physicians and other medical professionals, may use a template selected from a group of templates geared towards physicians. For example, the diction and terminology employed in each of the templates may vary. Moreover, between templates in a given set, the medical specialty, cause of visit, etc. may be different.

The complaint tree data structure 324 may be used by the system to generate sentences. A template may contain a string with one or more variables, where each variable value may be an entity in a complaint tree structure. The string may change based on how many entities are available for a specific block, e.g., the string may be different if there is a single medication versus if there are multiple medications for a specific complaint. In some embodiments, the templates used to create sentences may be dynamic in that a given field in the complaint tree data structure may dictate the structure and/or syntax of the sentences generated using templates. As described herein, in some embodiments, templates used to create sentences may be personalized (including by being automatically personalized by the system) for different doctors, healthcare facilities, healthcare systems, etc. Templates may also be dynamic in that they may be updated over time based on user feedback (e.g., feedback from physicians). In some embodiments, as shown in FIG. 4E, a medical note template for a statement in the HPI section of the medical note may recite, “Patient's current medications include: [blank],” and the system may be configured to extract current medications from the complaint tree data structure to fill in the text fields accordingly. Likewise, a template for the A/P medical note section may recite, “I recommended the patient [blank],” and the natural language statement generator may retrieve ordered medications or treatments from the complaint tree data structure to fill the text field(s). In some embodiments, output data may be aggregated to provide a deliverable to the user. For example, the determined medical coding, complaint ID, and/or visit type may be implemented to the medical note, as shown in FIG. 4E.

In some embodiments, the stored templates comprising predefined sentence structures may be based on known demographic information of the patient (e.g., retrieved from previous medical records in medical records library 118), such as by inserting the patient's name into the statement and/or by configuring pronouns in the statement according to the gender for the patient. In some embodiments, the template may be based on practitioner information, user specialty, a healthcare system, a payer, and/or a clinician preference.

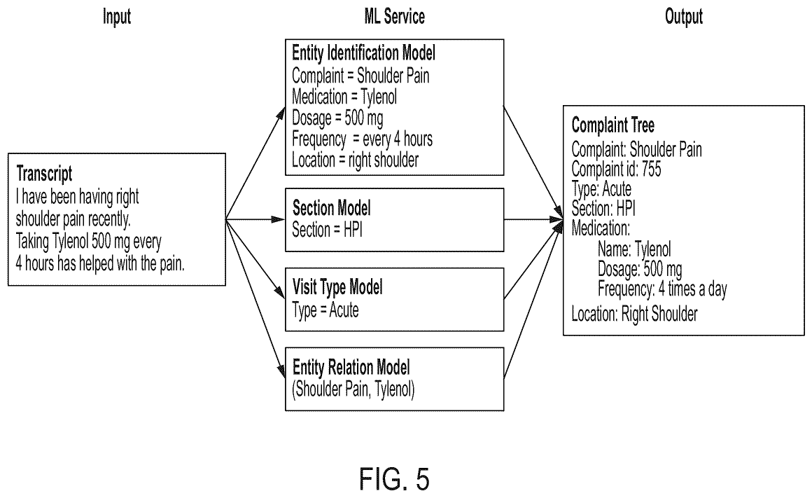

FIG. 5 depicts an overview of the complaint tree generating process using input transcript data, according to some embodiments. For example, at least a portion of transcript data may be received by one or more NLP models, such as medical entity models, relationship models, and section models (described above with regards to FIG. 3B), as well as visit type models. The models may be configured to extract and/or determine one or more features from the transcript data. For example, the medical entity models may identify the complaint, medication, dosage, frequency, and location from the transcript data. The section models may determine (e.g., using contextual data in the transcript) that the portion of the transcript is related to the history of present illness (HPI) section (e.g., visit segment). One or more visit type models may determine that the visit is acute, as shown. Additionally, one or more medical entity relationship models may determine relationships between extracted entities, such as “shoulder pain” and “Tylenol.” The relationships, entities, and sections determined using NLP models may be mapped within a complaint tree data structure output, as shown in FIG. 5.

### Method for Generating Structured Medical Data

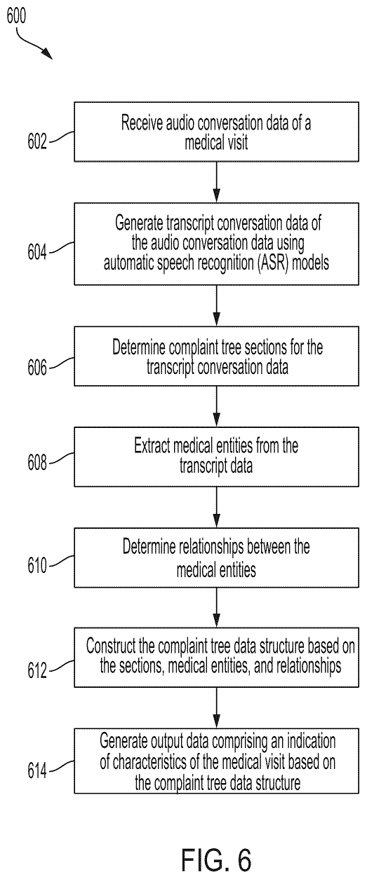

FIG. 6 depicts a flow chart describing a method 600 for generating a complaint tree data structure from audio conversation data. In some embodiments, method 600 may be performed by a system configured to provide a medical record generation platform, such as system 100 described above with reference to FIG. 1.

At block 602, a system may receive audio conversation data of a medical visit. In some embodiments, the audio conversation data may comprise dictation of one party (e.g., a physician). In some embodiments, the audio conversation data may comprise dialogue between two or more parties (e.g., a physician and a patient).

At block 604, the system may generate transcript conversation data based on the received audio conversation data. The system may apply one or more automatic speech recognition (ASR) models to generate the transcript conversation data. For example, a first ASR model may specialize in processing single-party audio data, and a second ASR model may specialize in processing multi-party conversation data; thus, the system may dynamically select one or more ASR models for use in processing the audio conversation data. In some embodiments, the ASR models may alternate in processing different portions of the audio conversation data (e.g., the first ASR model may process a first and second portion of the audio data, and a second ASR model may process a third and fourth portion of the audio data). The transcript data may be processed using one or more post-processing steps, such as by applying one or more ASR rules and context models. The context models may be based at least in part on the physician's specialty and/or the patient's medical history.

Based on the generated transcript data, the system may determine and extract one or more features from the transcript data to be included in the structured medical data (e.g., complaint tree data structure). In some embodiments, prior to extracting/determining the features, the transcript data may be pre-processed (e.g., tokenized). At block 606, the system may use one or more natural language processing (NLP) models (e.g., section models 310) to determine one or more complaint tree sections related to the tokenized transcript data. In some embodiments, pre-defined sections may include history of present illness (HPI), review of systems (ROS), physical examination (PE), and/or assessment/plan (A/P). In some embodiments, a classification layer may classify the tokenized transcript data based on the pre-defined sections to produce section-classified data.

At block 608, the system may use one or more NLP models (e.g., medical entity models 312) to extract medical entities. In some embodiments, the extracted medical entities may include a symptom, onset mode of a symptom, onset timing of a symptom, timing or frequency information, location of a symptom, contextual information, quality of a symptom, a prior or current medical condition, a diagnosis, a prior or current medication, a medication to be prescribed, a prior or current treatment, a treatment to be prescribed, prior or current lab tests, lab tests to be ordered, lab test results information, prior or current imaging procedures, imaging procedures to be ordered, imaging procedure results information, an organ system, a prior or current diagnostic procedure, a diagnostic procedure to be prescribed, results of a diagnostic procedure, prior or current treatments, and/or a treatment to be prescribed. The NLP models may include a named entity recognition (NER) layer configured to identify and label the types of medical entities in the transcript data. In some embodiments, the system may map the medical entity data to synonyms of one or more medical entities.

At block 610, the system may use one or more NLP models (e.g., medical entity relationship models 314) to determine relationships between medical entities. The medical entity relationship models may include a classification layer configured to classify whether two or more extracted medical entities are related. In some embodiments, the determined relationships between medical entities may be validated, for example, using medical standards and/or guidelines. In some embodiments, one or more of the aforementioned NLP models may be trained using training data comprising annotations indicating one or more of representative medical entities, representative relationships between medical entities, and representative sections for a complaint tree data structure.

At block 612, the medical entities, relationships, and sections may be compiled to construct a complaint tree data structure. In some embodiments, the complaint tree data structure may be organized by complaint (e.g., in the instance a medical visit comprises more than one complaint of a patient). In some embodiments, each complaint may comprise one or more sections, and the extracted medical entities may be sorted within the sections. In some embodiments, the complaint tree data structure may be based on a template of the complaint tree. In some embodiments, the system may apply medical data stored in a data store (e.g., an electronic medical record) to the complaint tree data structure.

At block 614, the constructed complaint tree data structure may be applied to generate output data comprising an indication of one or more characteristics of the medical visit. The system may extract one or more features (e.g., medical entities) from the complaint tree data structure and insert the medical entities into a template corresponding to the type of output data. For example, the type of output data may comprise a medical note of the medical visit, a care reminder (e.g., notification) during the visit, an after-visit summary of the medical visit, a billing code corresponding to the medical visit, and/or a pre-charting summary for subsequent medical visits. For example, in creating a medical note, a medical note template may comprise sections such as HPI, ROS, PE, and/or A/P, and the medical entities stored in the complaint tree data structure may be inserted into the corresponding sections of the note. In some embodiments, the output data and/or structured medical data may be stored in an electronic health record (EHR) of the patient.

In some embodiments, the complaint tree data may be applied in data analytics, for example, to analyze trends in healthcare and/or make data-backed decisions. In a non-limiting example, data analytics of the stored complaint tree data structure may include analyzing the number of prescriptions of a given medication prescribed by a physician to determine if the physician is overly prescribing the given medication. In another example, data analytics using the stored complaint tree data structures may include attempting to identify a correlation between specific treatments and long-term health outcomes for patients.

### Device for Generating Structured Medical Data

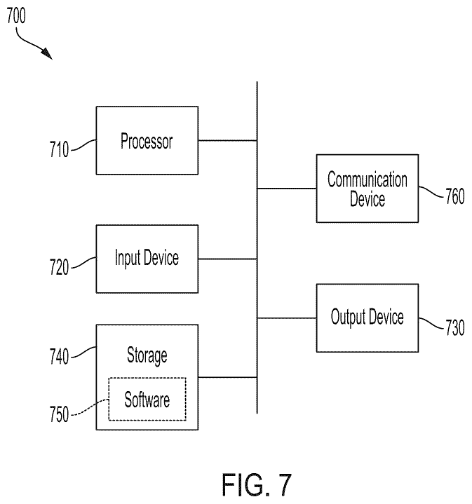

FIG. 7 illustrates an example of a computer, according to some embodiments. In some embodiments, computer 700 may execute a method for automatically generating structured medical data from audio conversation data of a medical visit.

Computer 700 can be a host computer connected to a network. Computer 700 can be a client computer or a server. As shown in FIG. 7, computer 700 can be any suitable type of microprocessor-based device, such as a personal computer, workstation, server, or handheld computing device, such as a phone or tablet. The computer can include, for example, one or more of processor 710, input device 720, output device 730, storage 740, and communication device 760. Input device 720 and output device 730 can correspond to those described above and can either be connectable or integrated with the computer.

Input device 720 can be any suitable device that provides input, such as a touch screen or monitor, keyboard, mouse, or voice-recognition device. Output device 730 can be any suitable device that provides an output, such as a touch screen, monitor, printer, disk drive, or speaker.

Storage 740 can be any suitable device that provides storage, such as an electrical, magnetic, or optical memory, including a random-access memory (RAM), cache, hard drive, CD-ROM drive, tape drive, or removable storage disk. Communication device 760 can include any suitable device capable of transmitting and receiving signals over a network, such as a network interface chip or card. The components of the computer can be connected in any suitable manner, such as via a physical bus or wirelessly. Storage 740 can be a non-transitory computer-readable storage medium comprising one or more programs, which, when executed by one or more processors, such as processor 710, cause the one or more processors to execute methods described herein.

Software 750, which can be stored in storage 740 and executed by processor 710, can include, for example, the programming that embodies the functionality of the present disclosure (e.g., as embodied in the systems, computers, servers, and/or devices as described above). In some embodiments, software 750 can include a combination of servers such as application servers and database servers.

Software 750 can also be stored and/or transported within any computer-readable storage medium for use by or in connection with an instruction execution system, apparatus, or device, such as those described above, that can fetch and execute instructions associated with the software from the instruction execution system, apparatus, or device. In the context of this disclosure, a computer-readable storage medium can be any medium, such as storage 740, that can contain or store programming for use by or in connection with an instruction execution system, apparatus, or device.

Software 750 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include but is not limited to, an electronic, magnetic, optical, electromagnetic, or infrared wired or wireless propagation medium.

Computer 700 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, Ti or T3 lines, cable networks, DSL, or telephone lines.

Computer 700 can implement any operating system suitable for operating on the network. Software 750 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

As used herein, the singular forms “a,” “an,” and “the” are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

The numerical ranges disclosed inherently support any range or value within the disclosed numerical ranges, including the endpoints, even though a precise range limitation is not stated verbatim in the specification because this disclosure can be practiced throughout the disclosed numerical ranges.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims.

1. A system for generating a complaint tree data structure based on audio conversation data of a medical visit, the system comprising one or more processors configured to cause the system to:
receive the audio conversation data of the medical visit;
generate transcript conversation data based on the audio conversation data using one or more automatic speech recognition (ASR) models;
determine a corresponding complaint tree section based on the transcript conversation data;
extract a plurality of medical entities from the transcript conversation data, wherein the plurality of medical entities correspond with the determined complaint tree section;
determine a relationship between two or more medical entities of the plurality of extracted medical entities;
construct a complaint tree data structure based at least in part on the complaint tree section, the plurality of extracted medical entities, and the relationship between the two or more medical entities; and
generate output data comprising an indication of one or more characteristics of the medical visit based on the constructed complaint tree data structure.

2. The system of claim 1, wherein generating the output data comprises:
extracting one or more medical entities from the constructed complaint tree data structure; and
inserting the one or more extracted medical entities into a template corresponding to a type of output data.

3. The system of claim 2, wherein the type of output data is selected from the group consisting of: a medical note of the medical visit, a care reminder during the medical visit, an after-visit summary of the medical visit, a billing code corresponding to the medical visit, and a pre-charting summary for a subsequent medical visit.

4. The system of claim 1, wherein the complaint tree section is selected from the group consisting of: history of present illness, review of systems, physical examination, and assessment/plan.

5. The system of claim 1, wherein the audio conversation data includes a first portion comprising audio data of an individual and a second portion comprising audio data of a dialogue between two or more individuals.

6. The system of claim 5, wherein generating the transcript conversation data comprises:
generating a first portion of the transcript conversation data using a first automatic speech recognition (ASR) model of the one or more ASR models based on the first portion of the audio conversation data; and
generating a second portion of the transcript conversation data using a second ASR model of the one or more ASR models based on the second portion of the audio conversation data.

7. The system of claim 1, comprising applying one or more rules to the transcript conversation data generated by the one or more automatic speech recognition (ASR) models, the one or more rules based at least in part on a physician's specialty and/or a patient's medical history.

8. The system of claim 1, wherein the section is determined using a first natural language processing (NLP) model, the plurality of medical entities are extracted using a second NLP model, and the relationship between two or more entities is determined using a third NLP model.

9. The system of claim 8, wherein one or more of the first, second, and third natural language processing (NLP) model are trained using training data comprising annotations indicating one or more of representative medical entities, representative relationships between medical entities, and representative sections.

10. The system of claim 1, comprising, for a medical entity of the plurality of extracted medical entities, mapping one or more synonyms of the medical entity to the medical entity.

11. The system of claim 1, comprising, for a medical entity of the plurality of extracted medical entities, determining a medical entity type of the medical entity.

12. The system of claim 11, wherein the medical entity type is selected from the group consisting of: complaints, history, timing, assessment, symptoms, location, medication, tests, and treatment.

13. The system of claim 1, comprising validating the relationship between the two or more entities using medical standards and/or guidelines.

14. The system of claim 1, comprising determining a visit type based on the transcript conversation data.

15. The system of claim 14, wherein the visit type is selected from the group consisting of: routine care, follow-up visits for non-urgent problems, and urgent visits for acute illness.

16. The system of claim 1, comprising storing the output data in an electronic health record (EHR) corresponding to a patient of the medical visit.

17. The system of claim 1, wherein the complaint tree data structure is constructed based on a complaint tree data structure template.

18. The system of claim 17, wherein the complaint tree data structure template is organized based on one or more complaint-type medical entities, each complaint-type medical entity comprising one or more sections.

19. The system of claim 1, comprising using the complaint tree data structure to generate analytics output data.

20. A method for generating a complaint tree data structure based on audio conversation data of a medical visit, the method comprising:
receiving the audio conversation data of the medical visit;
generating transcript conversation data based on the audio conversation data using one or more automatic speech recognition (ASR) models;
determining a corresponding complaint tree section based on the transcript conversation data;
extracting a plurality of medical entities from the transcript conversation data, wherein the plurality of medical entities correspond with the determined complaint tree section;
determining a relationship between two or more medical entities of the plurality of extracted medical entities;
constructing a complaint tree data structure based at least in part on the complaint tree section, the plurality of extracted medical entities, and the relationship between the two or more medical entities; and
generating output data comprising an indication of one or more characteristics of the medical visit based on the constructed complaint tree data structure.

21. A non-transitory computer-readable storage medium storing one or more programs for generating a complaint tree data structure based on audio conversation data of a medical visit, the programs for execution by one or more processors of an electronic device that when executed by the device, cause the device to:
receive the audio conversation data of the medical visit;
generate transcript conversation data based on the audio conversation data using one or more automatic speech recognition (ASR) models;
determine a corresponding complaint tree section based on the transcript conversation data;
extract a plurality of medical entities from the transcript conversation data, wherein the plurality of medical entities correspond with the determined complaint tree section;
determine a relationship between two or more medical entities of the plurality of extracted medical entities;
construct a complaint tree data structure based at least in part on the complaint tree section, the plurality of extracted medical entities, and the relationship between the two or more medical entities; and
generate output data comprising an indication of one or more characteristics of the medical visit based on the constructed complaint tree data structure.
